(19) United States
(12) Patent Application Publication
(10) Pub. No.: US 2006/0133190 A1
(43) Pub. Date: Jun. 22, 2006

(54) Powder mixing microchip, system and method

(76) Inventors: Andreas Manz, DORTMUND (DE); Torsten Vilkner, London (GB)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/523,035

(22) PCT Filed: Aug. 1, 2003
(86) PCT No.: PCT/GB03/03365

§ 371 Date: Jan. 5, 2006

(30) Foreign Application Priority Data
Aug. 2, 2002 (GB) 0217993.5

(51) Int. Cl. B01F 13/02

(52) U.S. Cl. 366/107

(57) ABSTRACT

A powder mixing microchip for mixing powder components, a powder mixing system incorporating the same and a powder mixing method for mixing powder components, the powder mixing microchip comprising: a powder mixing unit (1) for mixing a plurality of powder components to provide a powder mixture, the powder mixing unit including a powder mixing (5) channel in which powder components are mixed on being transported there through, a powder outlet port (8) through which the powder mixture is delivered, and a plurality of mixing gas supply channels (7) fluidly connected to the powder mixing channel at spaced locations along a length thereof through which mixing gas flows are delivered to effect mixing of the powder components on being transported through the powder mixing channel.

The present invention relates to a powder mixing microchip for mixing powder components, a powder mixing system incorporating the same, and a method of mixing powder components.

The mixing of powders is employed in many industries, for example, in the pharmaceuticals industry in the blending of dry granular powder compositions, such as for use as a powder or in the manufacture of tablets.

Numerous powder mixing techniques and associated systems have been developed in an attempt to provide for the optimized mixing of powders to achieve a homogenized mixture [1,2]. Such powder mixing techniques have been developed to handle powders of different size, typically particles, granules and lumps, different shape, typically spheres, pellets, flakes, filaments, blocks, crystals and irregularly-shaped particles, and different surface properties, typically cohesive and non-cohesive powders.

The existing powder mixing systems suffer from a number of disadvantages, particularly in relation to applications requiring the mixing of a large number of relatively-small amounts of different mixed powder compositions. One such application is in the pharmaceuticals industry in the development of new formulations, for example, new compound formulations or new dosage formulations, which require large numbers of relatively-small amounts of different mixed powder compositions for testing. The existing powder mixing systems utilize relatively-large amounts of powders and have relatively-long mixing times, requiring powders to be shaken, stirred or blended for several hours to obtain a homogeneous mixture. As will be appreciated, the time required to mix large numbers of different mixed powder compositions is very long when using existing powder mixing systems, and, moreover, is wasteful of material in requiring the mixing of amounts of material in excess of those required.

It is an aim of the present invention to provide a powder mixing microchip for mixing powder components, a powder mixing system incorporating the same, and an improved method of mixing powder components to provide powder mixtures.

In one aspect the present invention provides a powder mixing microchip, comprising: a powder mixing unit for mixing a plurality of powder components to provide a powder mixture, the powder mixing unit including a powder mixing channel in which powder components are mixed on being transported therethrough, a powder outlet port through which the powder mixture is delivered, and a plurality of mixing gas supply channels fluidly connected to the powder mixing channel at spaced locations along a length thereof through which mixing gas flows are delivered to effect mixing of the powder components on being transported through the powder mixing channel.

In one embodiment the powder mixing channel is an elongate, linear conduit.

In another embodiment the powder mixing channel comprises a series of mixing chambers interconnected by respective interconnecting conduits of smaller dimension, with the mixing gas supply channels being fluidly connected to the mixing chambers.

Preferably, the interconnecting conduits are configured such that inlets and outlets of the mixing chambers are not in opposing relation.

Preferably, the mixing gas supply channels are configured such as to provide a gas cushion which supports powder components transported through the powder mixing channel.

Preferably, the mixing gas supply channels are configured such as to provide turbulent gas flows in the powder mixing channel.

In one embodiment the mixing gas supply channels are equi-spaced.

In one embodiment the powder mixing unit includes first and second groups of mixing gas supply channels fluidly connected to respective ones of opposed sides of the powder mixing channel.

In one embodiment the first and second groups of mixing gas supply channels are in opposed relation.

In one embodiment the first and second groups of mixing gas supply channels are at a bottom of the powder mixing channel.

In another embodiment the first and second groups of mixing gas supply channels are at a top of the powder mixing channel.

In another embodiment the first and second groups of mixing gas supply channels are located at respective ones of a top and a bottom of the powder mixing channel.

In another embodiment the powder mixing unit includes first and second groups of mixing gas supply channels fluidly connected to one side of the powder mixing channel.

Preferably, the first and second groups of mixing gas supply channels are located at respective ones of a top and a bottom of the powder mixing channel.

In a further embodiment the powder mixing unit includes first and second groups of mixing gas supply channels fluidly connected to each of respective ones of opposed sides of the powder mixing channel.

Preferably, the first and second groups of mixing gas supply channels connected to each of the respective sides of the powder mixing channel are located at respective ones of a top and a bottom of the powder mixing channel.

Preferably, each respective group of mixing gas supply channels is fluidly connected by a manifold.

Preferably, the microchip further comprises: at least one powder delivery unit for delivering a plurality of powder components to the powder mixing channel.

More preferably, the microchip comprises: a plurality of powder delivery units for delivering a plurality of powder components to the powder mixing channel.

Preferably, each powder delivery unit includes a powder delivery channel fluidly connected to the powder mixing channel and through which at least one powder component is delivered to the powder mixing channel, at least one powder inlet port through which at least one powder component is supplied to the powder delivery channel, and a plurality of delivery gas supply channels fluidly connected to the powder delivery channel at spaced locations along a length thereof through which delivery gas flows are delivered at least in part to transport the at least one powder component to the powder mixing channel.

In one embodiment the powder delivery channel is an elongate, linear conduit.

Preferably, the delivery gas supply channels are configured such as to provide a gas cushion which supports the at least one powder component transported through the powder delivery channel.

Preferably, the delivery gas supply channels are configured such as to provide turbulent gas flows in the powder delivery channel.

In one embodiment the delivery gas supply channels are equi-spaced.

In one embodiment each powder delivery unit includes first and second groups of delivery gas supply channels fluidly connected to respective ones of opposed sides of the powder delivery channel.

In one embodiment the first and second groups of delivery gas supply channels are in opposed relation.

In one embodiment the first and second groups of delivery gas supply channels are at a bottom of the powder delivery channel.

In another embodiment the first and second groups of delivery gas supply channels are at a top of the powder delivery channel.

In another embodiment the first and second groups of delivery gas supply channels are located at respective ones of a top and a bottom of the powder delivery channel.

In another embodiment each powder delivery unit includes first and second groups of delivery gas supply channels fluidly connected to one side of the powder delivery channel.

Preferably, the first and second groups of delivery gas supply channels are located at respective ones of a top and a bottom of the powder delivery channel.

In a further embodiment each powder delivery unit includes first and second groups of delivery gas supply channels fluidly connected to each of respective ones of opposed sides of the powder delivery channel.

Preferably, the first and second groups of delivery gas supply channels connected to each of the respective sides of the powder delivery channel are located at respective ones of a top and a bottom of the powder delivery channel.

Preferably, each respective group of delivery gas supply channels is fluidly connected by a manifold.

In one embodiment each powder delivery unit includes a single powder inlet port.

In another embodiment at least one powder delivery unit includes a plurality of powder inlet ports.

In one embodiment each powder delivery unit includes a transport gas supply channel fluidly connected to the powder delivery channel for delivering a transport gas flow, separate to the delivery gas flows, through the powder delivery channel, which transport gas flow acts at least in part to transport the at least one powder component to the powder mixing channel.

In another aspect the present invention provides a powder mixing system, comprising: the above-described microchip.

Preferably, the system further comprises: a plurality of powder supply units fluidly connected to respective ones of the powder inlet ports for supplying respective ones of the powder components.

Preferably, the system further comprises: at least one gas supply unit operably fluidly connected to the mixing gas supply channels to supply a pressurized gas thereto.

Preferably, the at least one gas supply unit is operably fluidly connected to the delivery gas supply channels to supply a pressurized gas thereto.

In one embodiment the at least one gas supply unit is operably fluidly connected to the manifolds such as to enable control of relative flow rates of the delivery gas flows in the powder delivery channels of the respective powder delivery units, whereby delivery rates of powder components delivered by respective ones of the powder delivery units can be controlled such as to enable control of a mixing ratio of the powder mixture.

In another embodiment the at least one gas supply unit is operably fluidly connected to the transport gas supply channels such as to enable control of relative flow rates of the transport gas flows in the powder delivery channels of the respective powder delivery units, whereby delivery rates of powder components delivered by respective ones of the powder delivery units can be controlled such as to enable control of a mixing ratio of the powder mixture.

In a further aspect the present invention provides a powder mixing method, comprising the steps of: providing a powder mixing microchip comprising: a powder mixing unit for mixing a plurality of powder components to provide a powder mixture, the powder mixing unit including a powder mixing channel in which powder components are mixed on being transported therethrough; delivering a plurality of powder components to the powder mixing channel; and delivering a plurality of mixing gas flows to the powder mixing channel at spaced locations along a length thereof, which mixing gas flows act to mix the powder components during transport through the powder mixing channel.

Preferably, the mixing gas flows are such as to provide a gas cushion which supports powder components transported through the powder mixing channel.

Preferably, the mixing gas flows are such as to provide turbulent gas flows in the powder mixing channel.

In one embodiment the method comprises the step of: delivering first and second groups of mixing gas flows to the powder mixing channel from respective ones of opposed sides thereof.

In one embodiment the first and second groups of mixing gas flows are in opposed relation.

In one embodiment the first and second groups of mixing gas flows are from a bottom of the powder mixing channel.

In another embodiment the first and second groups of mixing gas flows are from a top of the powder mixing channel.

In another embodiment the first and second groups of mixing gas flows are from respective ones of a top and a bottom of the powder mixing channel.

In another embodiment the method comprises the step of: delivering first and second groups of mixing gas flows to the powder mixing channel from one side of the powder mixing channel.

Preferably, the first and second groups of mixing gas flows are from respective ones of a top and a bottom of the powder mixing channel.

In a further embodiment the method comprises the step of: delivering first and second groups of mixing gas flows to the powder mixing channel from each of respective ones of opposed sides of the powder mixing channel.

Preferably, the first and second groups of mixing gas flows from each of the respective sides of the powder mixing channel are from respective ones of a top and a bottom of the powder mixing channel.

Preferably, the powder mixing microchip further comprises: at least one powder delivery unit for delivering a plurality of powder components to the powder mixing channel, each powder delivery unit including a powder delivery channel fluidly connected to the powder mixing channel, and further comprising the step of: delivering a plurality of delivery gas flows to the powder delivery channel at spaced locations along a length thereof, which delivery gas flows act at least in part to transport the at least one powder component to the powder mixing channel.

Preferably, the delivery gas flows are such as to provide a gas cushion which supports the at least one powder component transported through the powder delivery channel.

Preferably, the delivery gas flows are such as to provide turbulent gas flows in the powder delivery channel.

In one embodiment the method comprises the step of: delivering first and second groups of delivery gas flows to the powder delivery channel from respective ones of opposed sides thereof.

In one embodiment the first and second groups of delivery gas flows are in opposed relation.

In one embodiment the first and second groups of delivery gas flows are from a bottom of the powder delivery channel.

In another embodiment the first and second groups of delivery gas flows are from a top of the powder delivery channel.

In another embodiment the first and second groups of delivery gas flows are from respective ones of a top and a bottom of the powder delivery channel.

In another embodiment the method comprises the step of: delivering first and second groups of delivery gas flows to the powder delivery channel from one side of the powder delivery channel.

Preferably, the first and second groups of delivery gas flows are from respective ones of a top and a bottom of the powder delivery channel.

In a further embodiment the method comprises the step of: delivering first and second groups of delivery gas flows to the powder delivery channel from each of respective ones of opposed sides of the powder delivery channel.

Preferably, the first and second groups of delivery gas flows from each of the respective sides of the powder delivery channel are from respective ones of a top and a bottom of the powder delivery channel.

In one embodiment the method further comprises the step of: delivering a transport gas flow, separate to the delivery gas flows, through the powder delivery channel, which transport gas flow acts at least in part to transport the at least one powder component to the powder mixing channel.

Preferably, the powder mixing microchip comprises: a plurality of powder delivery units for delivering a plurality of powder components to the powder mixing channel.

In one embodiment the method further comprises the step of: controlling relative flow rates of the delivery gas flows in the powder delivery channels of the respective powder delivery units such as to control delivery rates of powder components delivered by respective ones of the powder delivery units, and thereby enable control of a mixing ratio of the powder mixture.

In another embodiment the method further comprises the step of: controlling relative flow rates of the transport gas flows through the powder delivery channels of the respective powder delivery units such as to control delivery rates of powder components delivered by respective ones of the powder delivery units, and thereby enable control of a mixing ratio of the powder mixture.

Preferred embodiments of the present invention will now be described hereinbelow by way of example only with reference to the accompanying drawings, in which:

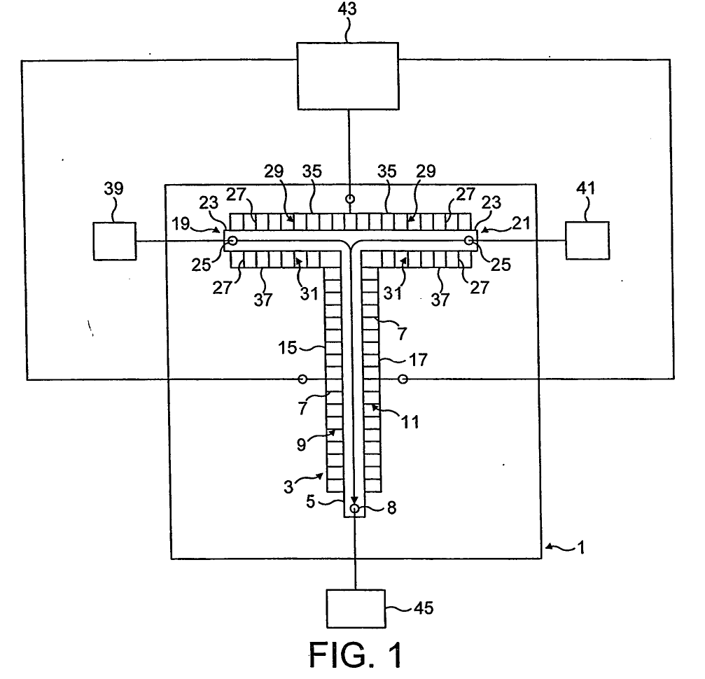

FIG. 1 schematically illustrates a powder mixing system in accordance with a first embodiment of the present invention;

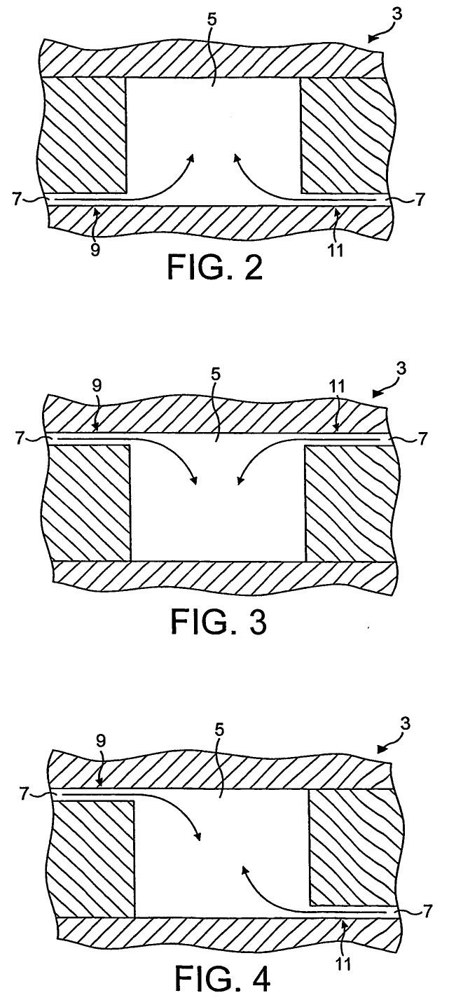

FIG. 2 illustrates a vertical sectional view through the mixing channel of the powder mixing unit of the powder mixing system of FIG. 1;

FIG. 3 illustrates a vertical sectional view through the mixing channel of the powder mixing unit of a powder mixing system as one modification of the powder mixing system of FIG. 1;

FIG. 4 illustrates a vertical sectional view through the mixing channel of the powder mixing unit of a powder mixing system as another modification of the powder mixing system of FIG. 1;

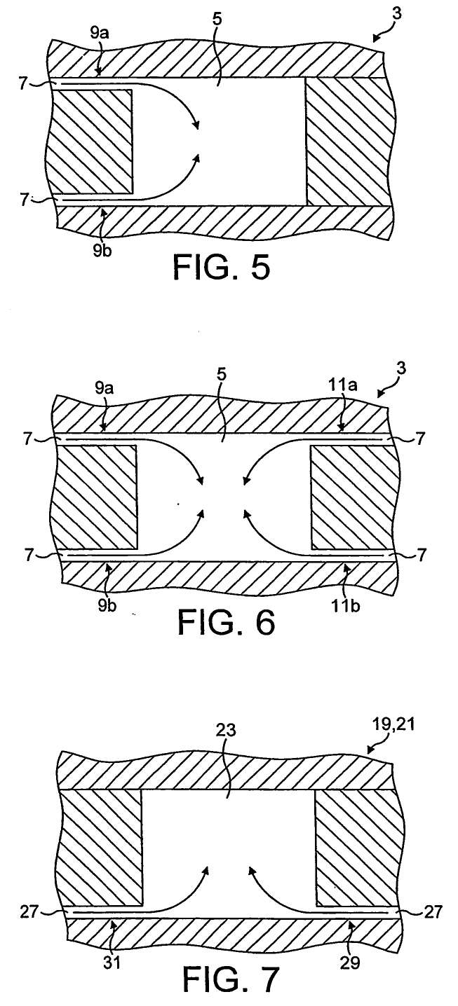

FIG. 5 illustrates a vertical sectional view through the mixing channel of the powder mixing unit of a powder mixing system as a further modification of the powder mixing system of FIG. 1;

FIG. 6 illustrates a vertical sectional view through the mixing channel of the powder mixing unit of a powder mixing system as a yet further modification of the powder mixing system of FIG. 1;

FIG. 7 illustrates a vertical sectional view through the powder supply channel of one powder supply unit of the powder mixing system of FIG. 1;

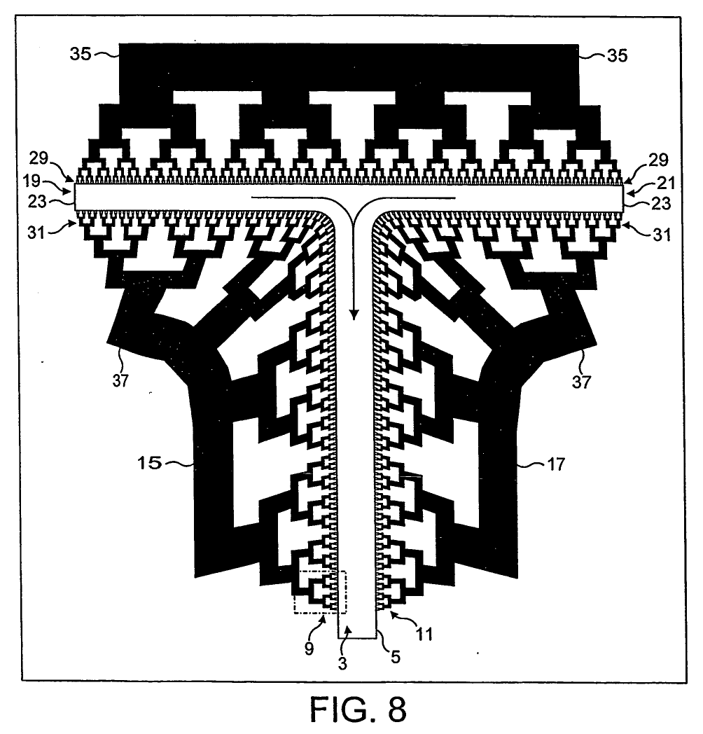

FIG. 8 illustrates the chip layout of the powder mixing device of the powder mixing system of FIG. 1;

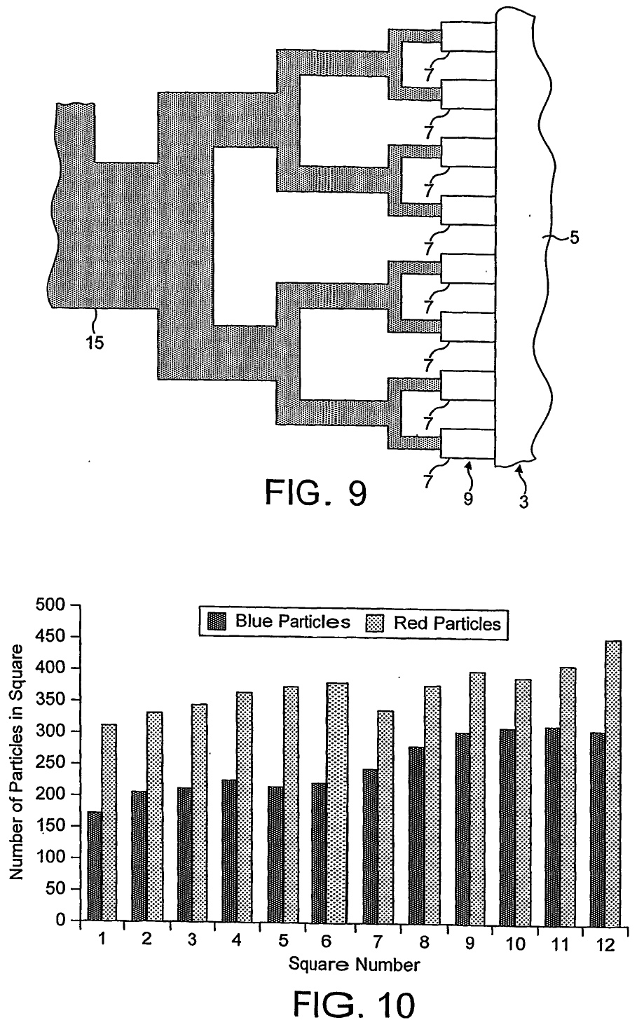

FIG. 9 illustrates in enlarged scale a fragmentary view of one stage of a manifold of the chip layout of FIG. 3;

FIG. 10 graphically represents data obtained in an Example (Example II) using the powder mixing system of FIG. 1;

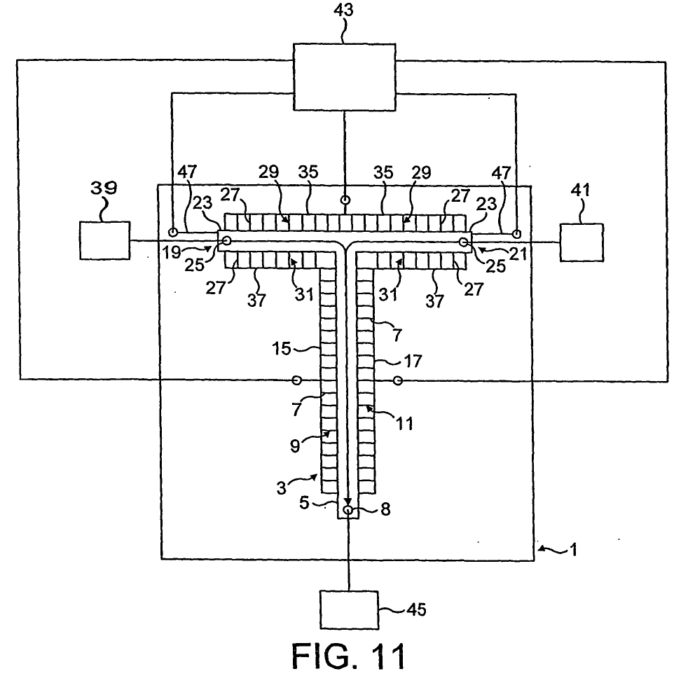

FIG. 11 schematically illustrates a powder mixing system in accordance with a second embodiment of the present invention;

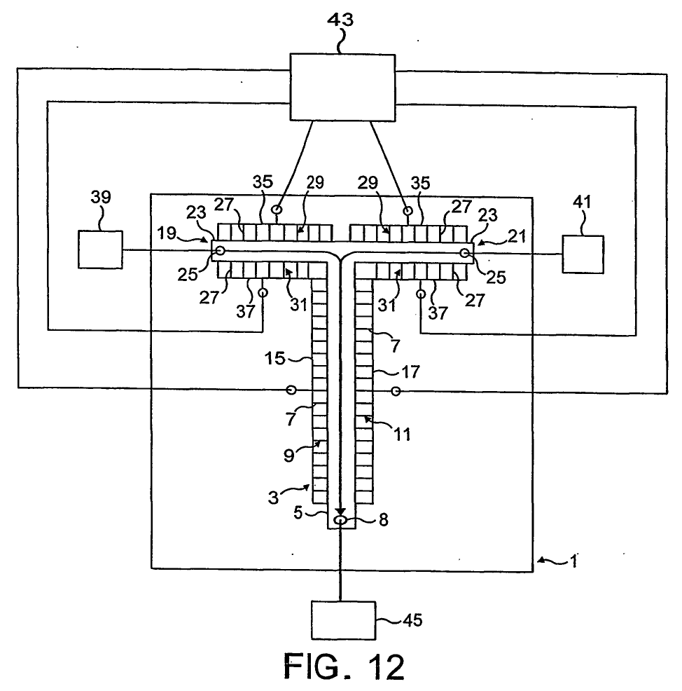

FIG. 12 schematically illustrates a powder mixing system in accordance with a third embodiment of the present invention;

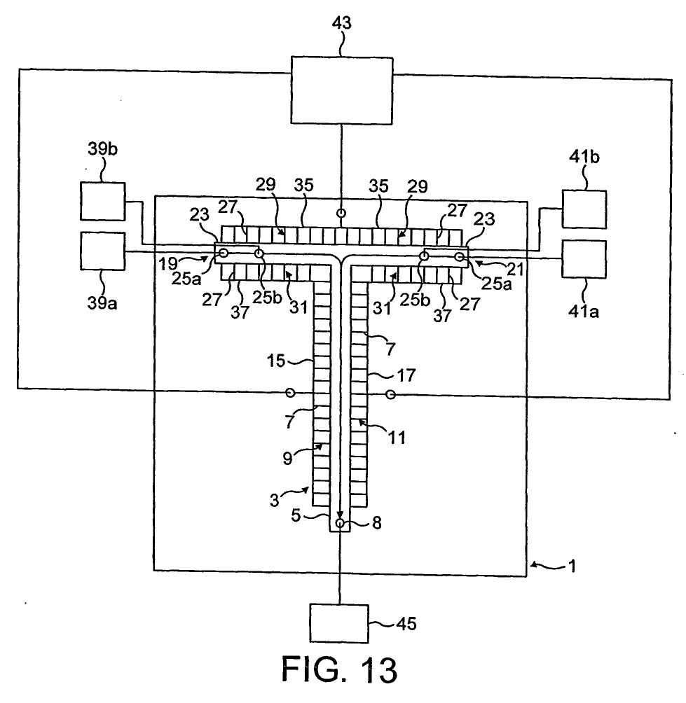

FIG. 13 schematically illustrates a powder mixing system in accordance with a fourth embodiment of the present invention;

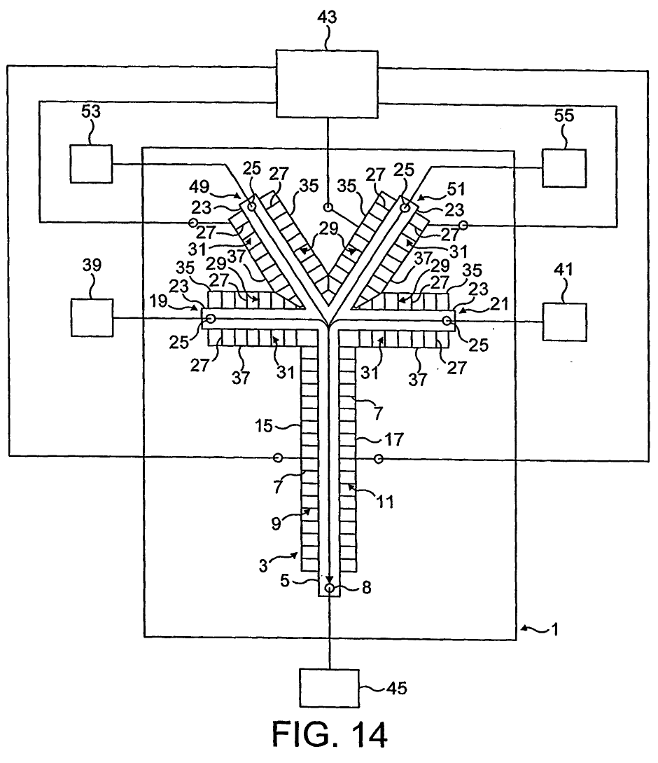

FIG. 14 schematically illustrates a powder mixing system in accordance with a fifth embodiment of the present invention;

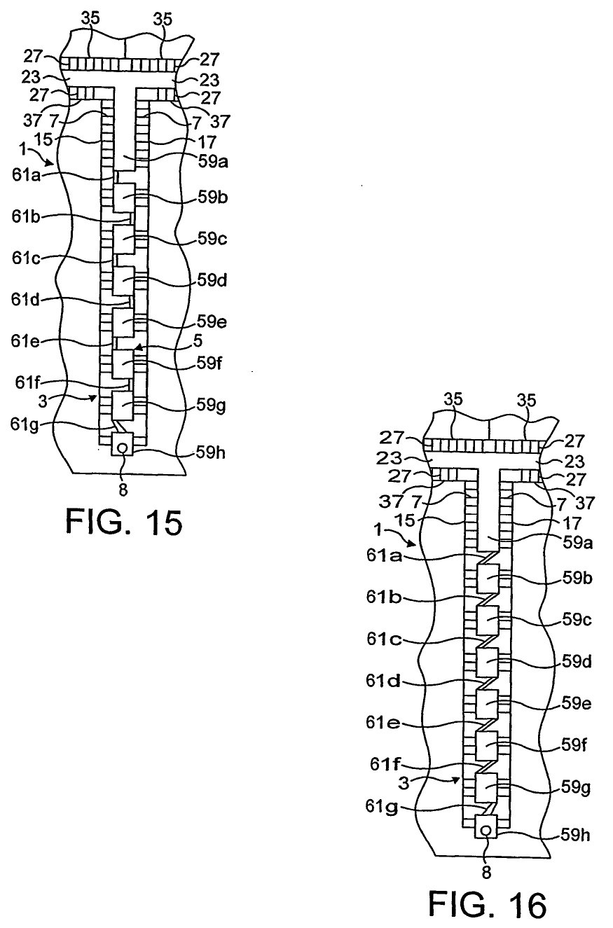

FIG. 15 illustrates the powder mixing unit of a powder mixing system as yet another modification of the powder mixing system of FIG. 1; and

FIG. 16 illustrates the powder mixing unit of a powder mixing system as still yet another modification of the powder mixing system of FIG. 1.

FIGS. 1 to 9 illustrate a powder mixing system in accordance with a first embodiment of the present invention.

The powder mixing system comprises a microfabricated powder mixing device 1, in this embodiment fabricated as a substrate chip, into which powder components are introduced and mixed to provide a homogeneous powder mixture.

The powder mixing device 1 includes a powder mixing unit 3 for mixing a plurality of powder components to provide a homogeneous powder mixture.

The powder mixing unit 3 includes a mixing channel 5 in which introduced powder components are mixed on passing therethrough, and a plurality of mixing gas supply channels 7 which are fluidly connected to the mixing channel 5 at spaced locations along the length thereof.

The mixing channel 5, in this embodiment an elongate, linear conduit, includes an outlet port 8 at one, downstream end thereof from which a homogeneous powder mixture is delivered. In this embodiment the mixing channel 5 has a width of about 1 mm and a depth of about 1 mm. In preferred embodiments the mixing channel 5 has a width of up to about 5 mm.

The mixing gas supply channels 7, in this embodiment equi-spaced along the length of the nixing channel 5, act to provide a gas cushion which supports the powder particles being transported through the mixing channel 5, and also turbulent gas flows in the mixing channel 5 which are such as to effect the mixing of the respective powder components during transport through the mixing channel 5. In this embodiment the mixing gas supply channels 7 have a width of about 50 μm and a depth of about 50 μm.

In this embodiment the mixing gas supply channels 7 are provided as first and second groups of supply channels 9, 11 along the respective elongate sides of the mixing channel 5, with each of the groups of supply channels 9, 11 being commonly fluidly connected by a respective manifold 15, 17. With this configuration, the delivered mixing gas flows interact to promote turbulent flow, and hence mixing of the powder components, in the mixing channel 5.

In this embodiment, as illustrated in FIG. 2, the mixing gas supply channels 7 of the first and second groups of supply channels 9, 11 are in opposed relation at the bottom of the mixing channel 5, with the upward action of the mixing gas flows acting to lift the powder particles and cause turbulence which is effective to mix the powder components.

In an alternative embodiment as a modification of the above-described first embodiment, as illustrated in FIG. 3, the mixing gas supply channels 7 of the first and second groups of supply channels 9, 11 can be in opposed relation at the top of the mixing channel 5. Although not providing the pronounced gas-cushion effect of the above-described first embodiment, the mixing gas flows from the mixing gas supply channels 7 of the first and second groups of supply channels 9, 11 are such as to provide for the effective mixing of the powder components. In other embodiments the mixing gas supply channels 7 of the first and second groups of supply channels 9, 11 could be provided at any location intermediate the top and bottom of the mixing channel 5, for example, at the mid-point of the elongate sides of the mixing channel 5.

In another alternative embodiment as another modification of the above-described first embodiment, as illustrated in FIG. 4, the mixing gas supply channels 7 of the first and second groups of supply channels 9, 11 can be located at respective ones of the top and bottom of the mixing channel 5. Although not in opposed relation, the mixing gas flows from the mixing gas supply channels 7 of the first and second groups of supply channels 9, 11 provide a gas-cushion effect, and are such as to provide for the effective mixing of the powder components.

In a further alternative embodiment as a further modification of the above-described first embodiment, as illustrated in FIG. 5, the mixing gas supply channels 7 can be provided as first and second groups of supply channels 9a, 9b along one elongate side of the mixing channel 5. In this embodiment the first and second groups of supply channels 9a, 9b are provided to respective ones of the top and bottom of the mixing channel 5. In other embodiments the mixing gas supply channels 7 of one or both of the first and second groups of supply channels 9a, 9b could be provided at locations intermediate the top and bottom of the mixing channel 5.

In a yet further alternative embodiment as a yet further modification of the above-described first embodiment, as illustrated in FIG. 6, the mixing gas supply channels 7 can be provided as first and second groups of supply channels 9a, 9b, 11a, 11b along each of the respective elongate sides of the mixing channel 5, with the first and second groups of supply channels 9a, 9b, 11a, 11b at each respective side of the mixing channel 5 being commonly fluidly connected by a respective manifold 15, 17. In this embodiment the first and second groups of supply channels 9a, 9b, 11a, 11b at each respective side of the mixing channel 5 are provided to respective ones of the top and bottom of the mixing channel 5.

The powder mixing device 1 further comprises a plurality of, in this embodiment first and second, powder delivery units 19, 21 which are fluidly connected to the other, upstream end of the mixing channel 5, through which respective ones of the powder components of the powder mixture are supplied to the mixing channel 5.

Each of the powder delivery units 19, 21 includes a delivery channel 23, in this embodiment an elongate, linear conduit, which is fluidly connected at one, downstream end to the upstream end of the mixing channel 5 and closed at the other, upstream end such as to provide that a gas flow into the delivery channel 23 passes through the mixing channel 5, as will be described in more detail hereinbelow. In this embodiment the delivery channel 23 has a width of about 0.6 mm and a depth of about 1 mm.

The delivery channel 23 includes a powder inlet port 25 at the upstream end thereof through which a respective one of the powder components to be mixed is supplied.

Each of the powder delivery units 19, 21 includes a plurality of delivery gas supply channels 27 which are fluidly connected to the respective delivery channel 23 at spaced locations along the length thereof.

The delivery gas supply channels 27, in this embodiment equi-spaced along the length of the respective delivery channel 23, act to provide a gas cushion which supports the powder particles being transported through the respective delivery channel 23, and also turbulent gas flows which are such as to effect de-agglomeration of the powder particles of the respective powder component and transport the powder particles to and in part through the respective delivery channel 23.

In this embodiment the delivery gas supply channels 27, similarly to the mixing gas supply channels 7 of the powder mixing unit 3, are provided as first and second groups of supply channels 29, 31 along the respective elongate sides of the respective powder delivery channel 23, with each of the groups of supply channels 29, 31 being commonly fluidly connected by a respective manifold 35, 37. With this configuration, the delivered delivery gas flows interact to promote turbulent flow, and hence de-agglomerate and transport the powder particles of the respective powder component through the respective powder delivery channel 23.

In this embodiment, as illustrated in FIG. 7, the delivery gas supply channels 27 of the first and second groups of supply channels 29, 31 are in opposed relation at the bottom of the respective powder delivery channel 23, with the upward action of the gas flows acting to lift the powder particles and cause turbulence which is effective to de-agglomerate the powder particles of the respective powder component.

In other alternative embodiments as modifications of the above-described first embodiment, the delivery gas supply channels 27 can have any of the alternative configurations described hereinabove for the mixing gas supply channels 7 of the powder mixing unit 3.

The powder mixing system further comprises a plurality of, in this embodiment first and second, powder supply units 39, 41 which are fluidly connected to respective ones of the powder inlet ports 25 of the powder delivery units 19, 21 for supplying the respective ones of the powder components. In this embodiment the powder supply units 39, 41 comprise reservoirs containing amounts of the respective powder components, with the effect of the gas flows through the respective powder delivery channels 23 being such as to cause the respective powder components to be metered into the respective ones of the powder delivery channels 23. In one alternative embodiment the powder supply units 39, 41 could include means for assisting the gravitational supply of the respective powder components, such as a vibrating mechanism for vibrating the contained powder components. In another alternative embodiment the powder supply units 39, 41 could include a metering mechanism for metering the supply of the respective powder components.

The powder mixing system further comprises a gas supply unit 43 for supplying a pressurised gas, in this embodiment nitrogen, to the manifolds 15, 17, 35, 35, 37, 37 of the powder mixing unit 3 and the powder delivery units 19, 21. In an alternative embodiment the pressurised gas could comprise compressed air. In this embodiment the first manifold 15 of the powder mixing unit 3 and the second manifold 37 of the first powder delivery unit 19 are commonly fluidly connected, the second manifold 17 of the powder mixing unit 3 and the second manifold 37 of the second powder delivery unit 21 are commonly fluidly connected, and the first manifolds 35, 35 of the first and second powder delivery units 19, 21 are commonly fluidly connected. With this configuration, the flow rates of the gas flows through the respective manifold groups can be selectively controlled, whereby the flow rates of the gas flows, and hence the relative rates of delivery of the powder components, can be controlled to provide a required mixing ratio.

The powder mixing system further comprises a powder collection unit 45 for collecting the mixed powder from the outlet port 8 of the powder mixing unit 3. In an alternative embodiment the outlet port 8 of the powder mixing unit 3 could be directly connected in-line with downstream equipment to allow for on-line operation, such as analysis.

In this embodiment the powder mixing device 1 is fabricated from three stacked planar substrate plates, in this embodiment each composed of microsheet glass. In an alternative embodiment one or more of the plates, in particular an intermediate plate, could be composed of poly (dimethylsiloxane) (PDMS). One advantage of such material is that the material can be readily surface treated to prevent powder adhesion.

In a first step, the upper surface of a first, lower plate is etched, in this embodiment by HF glass etching, to form wells defining the mixing channel 5, the mixing gas supply channels 7 and the manifolds 15, 17 of the powder mixing unit 3, and the powder delivery channels 23, the delivery gas supply channels 27 and the manifolds 35, 37 of the powder delivery units 19, 21. FIGS. 8 and 9 illustrate the chip layout. It will be understood that the chip layout in FIG. 1 is represented schematically for ease of illustration. As will be noted, the manifolds 15, 17, 35, 35, 37, 37 each comprise a web-like array of channels which define a plurality of stages, with each of the stages having 2ⁿ channel outlets (where n=8) which are fluidly connected to respective ones of the mixing gas supply channels 7 and the delivery gas supply channels 27. In this embodiment the wells have a depth of 50 μm, the well defining the mixing channel 5 has a width of 1 mm, the wells defining the powder delivery channels 23 each have a width of 0.6 mm, and the wells defining the gas supply channels 7, 27 each have a width of 50 μm.

In a second step, one hole is bored into the first plate to define the outlet port 8 of the mixing channel 5.

In a third step, a second plate, in this embodiment defined by three sub-sheets having a thickness of 1 mm, is located on the upper surface of the first plate such as to define the mixing channel 5 of the powder mixing unit 3 and the powder delivery channels 23 of the powder delivery units 19, 21.

In a fourth step, five holes are bored in a third plate to define the two powder inlet ports 25 of the powder delivery channels 23 of the powder delivery units 19, 21 and three fluid communication ports for providing fluid communication with respective ones of the manifolds 15, 17, 35, 35, 37, 37. In this embodiment, as described hereinabove, there are three manifold groups.

In a fifth step, pipette tips providing the first and second powder supply units 39, 41 are bonded to the respective holes bored in the third plate which define the powder inlet ports 25 of the powder delivery units 19, 21. In use, the pipette tips providing the powder supply units 39, 41 are each filled with amounts of a respective powder component, and hermetically closed.

In a sixth step, the third plate is located over the second plate.

In a seventh and final step, the plates are thermally bonded to define an integral unit.

Operation of the above-described powder mixing system will now be described with reference to the following non-limiting Examples.

### EXAMPLE I

In this Example, the powder mixing system of the above-described first embodiment was operated using a number of different powder materials which are commonly used in pharmaceutical compositions, and established the operation of the powder mixing system in transporting such powder materials from pipette tips providing the powder supply units 39, 41, through the powder delivery channels 23 of the powder delivery units 19, 21 to the mixing channel 5 of the powder mixing unit 3, and through the mixing channel 5 of the powder mixing unit 3 to the outlet port 8 of the mixing channel 5. The materials were microcrystalline cellulose (Avicel PH101®, Avicel PH301®, Honeywell & Stein Ltd.), magnesium stearate (aroxite Ltd.), titanium dioxide (Tioxide®, Tioxide Europe Ltd.), dicalcium phosphate anhydrous (Fujicalin®, Fuji Chemical Industry Co.), and Lactose (Lactopress®, Lactochem®, Borculo Domo Ingredients Ltd.). Each of these materials was loaded in turn into both of the pipette tips defining the powder supply units 39, 41, noting that the purpose of this Example was not to establish mixing of different powder components, but rather effective transport through the powder mixing device 1, and, in operation, the powder components contained in the pipette tips were continually drawn therefrom by the action of the respective gas flows through the powder delivery channels 23 of the powder delivery units 19, 21.

### EXAMPLE II

In this Example, the powder mixing system of the above-described first embodiment was operated to mix two lactose (Lactopress®, Borculo Domo Ingredients Ltd.) powder samples.

In a first step, the lactose samples were dyed using different colour dyes, that is, blue and red dyes to enable analysis of the powders when mixed. The blue lactose powder was obtained by immersing one lactose powder sample in a solution of methylene blue in dichloromethane, and evaporating the solvent. The red lactose powder was obtained by immersing the other lactose powder sample in a solution of Sudan red in diethylether, and evaporating the solvent.

Equal amounts, in this Example 5 g, of the lactose powder samples were then loaded into respective ones of the pipette tips defining the powder supply units 39, 41.

The gas supply unit 43 was then actuated to deliver gas flows through the gas supply channels 7, 27, and the powder samples were drawn from the respective pipette tips providing the powder supply units 39, 41, transported through the powder delivery channels 23 of the powder delivery units 19, 21 to the mixing channel 5 of the powder mixing unit 3, transported through the mixing channel 5 of the powder mixing unit 3 to the outlet port 8 of the mixing channel 5, and delivered from the outlet port 8 of the mixing channel 5 as a mixed powder.

The mixed powder was collected at a number of separate sites of the same size, in this Example twelve squares on an adhesive substrate, for analysis, with the material collected in each square representing a period of mixed powder delivery from the outlet port 8 of the mixing channel 5.

The numbers of differently-coloured particles in each of the squares was then counted, with the relative numbers of the differently-coloured powders in each square representing a measure of the homogeneity of the powder mixture. FIG. 10 graphically represents the numbers of the differently-coloured particles in each of the twelve squares. The ratio of the differently-coloured particles was determined as 0.66±0.09. The relative differences in the numbers of the differently-coloured particles in each square is attributed to the different particle size distributions of the two lactose powder samples, and the progressive increase in the numbers of both coloured particles in the squares is attributed to the collection substrate being disposed at a different angle to the delivered flow of the mixed powder during collection in the squares. This notwithstanding, the results clearly establish that a homogeneous mixture is generated.

FIG. 11 illustrates a powder mixing system in accordance with a second embodiment of the present invention.

The powder mixing system of this embodiment is very similar to that of the above-described first embodiment, and thus, in order to avoid any unnecessary duplication of description, only the differences will be described in detail, with like parts being designated by like reference signs.

The powder mixing system of this embodiment differs from that of the above-described first embodiment only in that the powder delivery units 19, 21 each include a transport gas supply channel 47 which is fluidly connected to the upstream end of the delivery channel 23 of the respective powder delivery unit 19, 21. Each of the transport gas supply channels 47 is operably fluidly connected to the gas supply unit 43 so as to enable the delivery of a transport gas flow, separate to the delivery gas flows, through the respective powder delivery channels 23 of the powder delivery units 19, 21. By providing for the selective control of the transport gas flows, the delivery rates of the powder components delivered by the respective powder delivery units 19, 21 can be controlled such as to enable control of the mixing ratio of the powder mixture.

Operation is the same as for the powder mixing system of the above-described first embodiment, except that control of the mixing ratio is effected by controlling the flow rates of the transport gas flows delivered through the respective transport gas supply channels 47 of the powder delivery units 19, 21.

FIG. 12 illustrates a powder mixing system in accordance with a third embodiment of the present invention.

The powder mixing system of this embodiment is very similar to that of the above-described first embodiment, and thus, in order to avoid any unnecessary duplication of description, only the differences will be described in detail, with like parts being designated by like reference signs.

The powder mixing system of this embodiment differs from that of the above-described first embodiment only in that the manifolds 15, 17 of the powder mixing unit 3 and the manifolds 35, 37 of each of the powder delivery units 19, 21 are separately fluidly connected to the gas supply unit 43. With this configuration, the delivery rates of the powder components delivered by the respective powder delivery units 19, 21 can be controlled such as to enable control of the mixing ratio of the powder mixture.

Operation is the same as for the powder mixing system of the above-described first embodiment, except that control of the mixing ratio is effected by controlling the flow rates of the delivery gas flows delivered through the delivery gas supply channels 27 of the respective ones of the powder delivery units 19, 21.

FIG. 13 illustrates a powder mixing system in accordance with a fourth embodiment of the present invention.

The powder mixing system of this embodiment is very similar to that of the above-described first embodiment, and thus, in order to avoid any unnecessary duplication of description, only the differences will be described in detail, with like parts being designated by like reference signs.

The powder mixing system of this embodiment differs from that of the above-described first embodiment only in that the powder delivery channel 23 of each of the powder delivery units 19, 21 includes a plurality of, in this embodiment first and second, powder inlet ports 25a, 25b, and in that the powder mixing system comprises first to fourth powder supply units 39a, 39b, 41a, 41b, each fluidly connected to a respective one of the powder inlet ports 25a, 25b of the powder delivery units 19, 21. With this configuration, the powder mixing system can provide for the mixing of four separate powder components. It will be understood that the embodied powder mixing system could be modified to mix any number of powder components by providing a corresponding number of inlet ports 25 and powder supply units 39, 41.

Operation is the same as for the powder mixing system of the above-described first embodiment, with each powder delivery unit 19, 21 providing two powder components to the mixing channel 5 of the powder mixing unit 3.

FIG. 14 illustrates a powder mixing system in accordance with a fifth embodiment of the present invention.

The powder mixing system of this embodiment is very similar to that of the above-described first embodiment, and thus, in order to avoid any unnecessary duplication of description, only the differences will be described in detail, with like parts being designated by like reference signs.

The powder mixing system of this embodiment differs from that of the above-described first embodiment only in comprising first to fourth powder delivery units 19, 21, 49, 51, each fluidly connected to the upstream end of the mixing channel 5 of the powder mixing unit 3, and first to fourth powder supply units 39, 41, 53, 55, each fluidly connected to a respective one of the powder inlet ports 25 of the powder delivery units 19, 21, 49, 51. With this configuration, the powder mixing system provides for the mixing of four separate powder components. It will be understood that the embodied powder mixing system could be modified to mix any number of powder components by providing a corresponding number of powder delivery units 19, 21, 49, 51 and powder supply units 39, 41, 53, 55.

Operation is the same as for the powder mixing system of the above-described first embodiment, with each powder delivery unit 19, 21, 49, 51 providing a respective one of four powder components to the mixing channel 5 of the powder mixing unit 3.

Finally, it will be understood that the present invention has been described in its preferred embodiments and can be modified in many different ways without departing from the scope of the invention as defined by the appended claims.

For example, in one modification, as illustrated in FIGS. 15 and 16, the mixing channel 5 of the powder mixing unit 3 could comprise a series of chambers 59a-h which are interconnected by relatively-narrow conduits 61a-g, with the mixing gas supply channels 7 being fluidly connected to the mixing chambers 59a-h. With this configuration, the residence time, and hence the mixing time, of the powder components in the mixing channel 5 is increased. In these embodiments the interconnecting conduits 61a-g are configured such that the inlet flow to any mixing chamber 59a-h is not opposed to the outlet flow from that mixing chamber 59a-h, such as to prevent direct flow through any mixing chamber 59a-h and thereby promote mixing of the powder components.

### REFERENCES

[1] L. T. Fan, Y. M. Chen, F. S. Lan, Powder Technology, 1990, 61, pp 255-287.
[2] M. Poux, P. Fayolle, J. Bertrand, D. Bridoux, J. Bousquet, Powder Technology, 1991, 68, pp 213-234.

1. A powder mixing microchip, comprising:
a powder mixing unit for mixing a plurality of powder components to provide a powder mixture, the powder mixing unit including a powder mixing channel in which powder components are mixed on being transported therethrough, a powder outlet port through which the powder mixture is delivered, and a plurality of mixing gas supply channels fluidly connected to the powder mixing channel at spaced locations along a length thereof through which mixing gas flows are delivered to effect mixing of the powder components on being transported through the powder mixing channel.

2. The microchip of claim 1, wherein the powder mixing channel is an elongate, linear conduit.

3. The microchip of claim 1, wherein the powder mixing channel comprises a series of mixing chambers interconnected by respective interconnecting conduits of smaller dimension, with the mixing gas supply channels being fluidly connected to the mixing chambers.

4. The microchip of claim 3, wherein the interconnecting conduits are configured such that inlets and outlets of the mixing chambers are not in opposing relation.

5. The microchip of claim 1, wherein the mixing gas supply channels are configured such as to provide a gas cushion which supports powder components transported through the powder mixing channel.

6. The microchip of claim 1, wherein the mixing gas supply channels are configured such as to provide turbulent gas flows in the powder mixing channel.

7. The microchip of clam 1, wherein the mixing gas supply channels are equi-spaced.

8. The microchip of claim 1, wherein the powder mixing unit includes first and second groups of mixing gas supply channels fluidly connected to respective ones of opposed sides of the powder mixing channel.

9. The microchip of claim 8, wherein the first and second groups of mixing gas supply channels are in opposed relation.

10. The microchip of claim 9, wherein the first and second groups of mixing gas supply channels are at a bottom of the powder mixing channel.

11. The microchip of claim 9, wherein the first and second groups of mixing gas supply channels are at a top of the powder mixing channel.

12. The microchip of claim 8, wherein the first and second groups of mixing gas supply channels are located at respective ones of a top and a bottom of the powder mixing channel.

13. The microchip of claim 1, wherein the powder mixing unit includes first and second groups of mixing gas supply channels fluidly connected to one side of the powder mixing channel.

14. The microchip of claim 13, wherein the first and second groups of mixing gas supply channels are located at respective ones of a top and a bottom of the powder mixing channel.

15. The microchip of claim 1, wherein the powder mixing unit includes first and second groups of mixing gas supply channels fluidly connected to each of respective ones of opposed sides of the powder mixing channel.

16. The microchip of claim 15, wherein the first and second groups of mixing gas supply channels connected to each of the respective sides of the powder mixing channel are located at respective ones of a top and a bottom of the powder mixing channel.

17. The microchip of claim 8, wherein each respective group of mixing gas supply channels is fluidly connected by a manifold.

18. The microchip of claim 1, further comprising:
at least one powder delivery unit for delivering a plurality of powder components to the powder mixing channel.

19. The microchip of claim 18, comprising:
a plurality of powder delivery units for delivering a plurality of powder components to the powder mixing channel.

20. The microchip of claim 18, wherein each powder delivery unit includes a powder delivery channel fluidly connected to the powder mixing channel and through which at least one powder component is delivered to the powder mixing channel, at least one powder inlet port through which at least one powder component is supplied to the powder delivery channel, and a plurality of delivery gas supply channels fluidly connected to the powder delivery channel at spaced locations along a length thereof through which delivery gas flows are delivered at least in part to transport the at least one powder component to the powder mixing channel.

21. The microchip of claim 20, wherein the powder delivery channel is an elongate, linear conduit.

22. The microchip of claim 20, wherein the delivery gas supply channels are configured such as to provide a gas cushion which supports the at least one powder component transported through the powder delivery channel.

23. The microchip of claim 20, wherein the delivery gas supply channels are configured such as to provide turbulent gas flows in the powder delivery channel.

24. The microchip of claim 20, wherein the delivery gas supply channels are equi-spaced.

25. The microchip of claim 20, wherein each powder delivery unit includes first and second groups of delivery gas supply channels fluidly connected to respective ones of opposed sides of the powder delivery channel.

26. The microchip of claim 25, wherein the first and second groups of delivery gas supply channels are in opposed relation.

27. The microchip of claim 26, wherein the first and second groups of delivery gas supply channels are at a bottom of the powder delivery channel.

28. The microchip of claim 26, wherein the first and second groups of delivery gas supply channels are at a top of the powder delivery channel.

29. The microchip of claim 25, wherein the first and second groups of delivery gas supply channels are located at respective ones of a top and a bottom of the powder delivery channel.

30. The microchip of claim 20, wherein each powder delivery unit includes first and second groups of delivery gas supply channels fluidly connected to one side of the powder delivery channel.

31. The microchip of claim 30, wherein the first and second groups of delivery gas supply channels are located at respective ones of a top and a bottom of the powder delivery channel.

32. The microchip of claim 20, wherein each powder delivery unit includes first and second groups of delivery gas supply channels fluidly connected to each of respective ones of opposed sides of the powder delivery channel.

33. The microchip of claim 32, wherein the first and second groups of delivery gas supply channels connected to each of the respective sides of the powder delivery channel are located at respective ones of a top and a bottom of the powder delivery channel.

34. The microchip of claim 20, wherein each respective group of delivery gas supply channels is fluidly connected by a manifold.

35. The microchip of claim 1, further comprising:
a plurality of powder delivery units for delivering a plurality of powder components to the powder mixing channel, wherein each powder delivery unit includes a powder delivery channel fluidly connected to the powder mixing channel and through which at least one powder component is delivered to the powder mixing channel, a single powder inlet port through which at least one powder component is supplied to the powder delivery channel, and a plurality of delivery gas supply channels fluidly connected to the powder delivery channel at spaced locations along a length thereof through which delivery cias flows are delivered at least in part to transport the at least one powder component to the powder mixing channel.

36. The microchip of claim 20, wherein at least one powder delivery unit includes a plurality of powder inlet ports.

37. The microchip of claim 20, wherein each powder delivery unit includes a transport gas supply channel fluidly connected to the powder delivery channel for delivering a transport gas flow, separate to the delivery gas flows, through the powder delivery channel, which transport gas flow acts at least in part to transport the at least one powder component to the powder mixing channel.

38. A powder mixing system, comprising: the microchip of claim 1.

39. The system of claim 38, further comprising:
a plurality of powder supply units fluidly connected to respective ones of the powder inlet ports for supplying respective ones of the powder components.

40. The system of claim 38, further comprising: at least one gas supply unit operably fluidly connected to the mixing gas supply channels to supply a pressurized gas thereto.

41. A powder mixing system, comprising:
the microchip of claim 20; and
at least one gas supply unit operably fluidly connected to the mixing gas supply channels and the delivery gas supply channels to supply a pressurized gas thereto.

42. A powder mixing system, comprising:
the microchip of claim 34, comprising:
a plurality of powder delivery units for delivering a plurality of powder components to the powder mixing channel; and
at least one gas supply unit operably fluidly connected to the mixing gas supply channels to supply a pressurised gas thereto, wherein the at least one gas supply unit is operably fluidly connected to the manifolds such as to enable control of relative flow rates of the delivery gas flows in the powder delivery channels of the respective powder delivery units, whereby delivery rates of powder components delivered by respective ones of the powder delivery units can be controlled such as to enable control of a mixing ratio of the powder mixture.

43. A powder mixing system, comprising:
the microchip of claim 37, comprising:
a plurality of powder delivery units for delivering a plurality of powder components to the powder mixing channel; and
at least one gas supply unit operably fluidly connected to the mixing gas supply channels to supply a pressurised gas thereto, wherein the at least one gas supply unit is operably fluidly connected to the transport gas supply channels such as to enable control of relative flow rates of the transport gas flows in the powder delivery channels of the respective powder delivery units, whereby delivery rates of powder components delivered by respective ones of the powder delivery units can be controlled such as to enable control of a mixing ratio of the powder mixture.

44. A powder mixing method, comprising the steps of:
providing a powder mixing microchip comprising: a powder mixing unit for mixing a plurality of powder components to provide a powder mixture, the powder mixing unit including a powder mixing channel in which powder components are mixed on being transported therethrough;
delivering a plurality of powder components to the powder mixing channel; and
delivering a plurality of mixing gas flows to the powder mixing channel at spaced locations along a length thereof, which mixing gas flows act to mix the powder components during transport through the powder mixing channel.

45. The method of claim 44, wherein the mixing gas flows are such as to provide a gas cushion which supports powder components transported through the powder mixing channel.

46. The method of claim 44, wherein the mixing gas flows are such as to provide turbulent gas flows in the powder mixing channel.

47. The method of claim 44, comprising the step of:
delivering first and second groups of mixing gas flows to the powder mixing channel from respective ones of opposed sides thereof.

48. The method of claim 47, wherein the first and second groups of mixing gas flows are in opposed relation.

49. The method of claim 48, wherein the first and second groups of mixing gas flows are from a bottom of the powder mixing channel.

50. The method of claim 48, wherein the first and second groups of mixing gas flows are from a top of the powder mixing channel.

51. The method of claim 47, wherein the first and second groups of mixing gas flows are from respective ones of a top and a bottom of the powder mixing channel.

52. The method of claim 44, comprising the step of:
delivering first and second groups of mixing gas flows to the powder mixing channel from one side of the powder mixing channel.

53. The method of claim 52, wherein the first and second groups of mixing gas flows are from respective ones of a top and a bottom of the powder mixing channel.

54. The method of claim 44, comprising the step of:
delivering first and second groups of mixing gas flows to the powder mixing channel from each of respective ones of opposed sides of the powder mixing channel.

55. The method of claim 54, wherein the first and second groups of mixing gas flows from each of the respective sides of the powder mixing channel are from respective ones of a top and a bottom of the powder mixing channel.

56. The method of claim 44, wherein the powder mixing microchip further comprises: at least one powder delivery unit for delivering a plurality of powder components to the powder mixing channel, each powder delivery unit including a powder delivery channel fluidly connected to the powder mixing channel, and further comprising the step of:
delivering a plurality of delivery gas flows to the powder delivery channel at spaced locations along a length thereof, which delivery gas flows act at least in part to transport the at least one powder component to the powder mixing channel.

57. The method of claim 56, wherein the delivery gas flows are such as to provide a gas cushion which supports the at least one powder component transported through the powder delivery channel.

58. The method of claim 56, wherein the delivery gas flows are such as to provide turbulent gas flows in the powder delivery channel.

59. The method of claim 56, comprising the step of:
delivering first and second groups of delivery gas flows to the powder delivery channel from respective ones of opposed sides thereof.

60. The method of claim 59, wherein the first and second groups of delivery gas flows are in opposed relation.

61. The method of claim 60, wherein the first and second groups of delivery gas flows are from a bottom of the powder delivery channel.

62. The method of claim 60, wherein the first and second groups of delivery gas flows are from a top of the powder delivery channel.

63. The method of claim 59, wherein the first and second groups of delivery gas flows are from respective ones of a top and a bottom of the powder delivery channel.

64. The method of claim 56, comprising the step of:
delivering first and second groups of delivery gas flows to the powder delivery channel from one side of the powder delivery channel.

65. The method of claim 64, wherein the first and second groups of delivery gas flows are from respective ones of a top and a bottom of the powder delivery channel.

66. The method of claim 56, comprising the step of:
delivering first and second groups of delivery gas flows to the powder delivery channel from each of respective ones of opposed sides of the powder delivery channel.

67. The method of claim 66, wherein the first and second groups of delivery gas flows from each of the respective sides of the powder delivery channel are from respective ones of a top and a bottom of the powder delivery channel.

68. The method of claim 56, further comprising the step of:
delivering a transport gas flow, separate to the delivery gas flows, through the powder delivery channel, which transport gas flow acts at least in part to transport the at least one powder component to the powder mixing channel.

69. The method of claim 56, wherein the powder mixing microchip comprises: a plurality of powder delivery units for delivering a plurality of powder components to the powder mixing channel.

70. The method of claim 56, wherein the powder mixing microchip comprises: a plurality of powder delivery units for delivering a plurality of powder components to the powder mixing channel; and further comprising the step of:
controlling relative flow rates of the delivery gas flows in the powder delivery channels of the respective powder delivery units such as to control delivery rates of powder components delivered by respective ones of the powder delivery units, and thereby enable control of a mixing ratio of the powder mixture.

71. The method of claim 69, further comprising the steps of:
delivering a transport gas flow, separate to the delivery gas flows, through the powder delivery channel, which transport cias flow acts at least in part to transport the at least one powder component to the powder mixing channel; and
controlling relative flow rates of the transport gas flows through the powder delivery channels of the respective powder delivery units such as to control delivery rates of powder components delivered by respective ones of the powder delivery units, and thereby enable control of a mixing ratio of the powder mixture.
